(19) United States
(12) Patent Application Publication
(10) Pub. No.: US 2009/0000414 A1
(43) Pub. Date: Jan. 1, 2009

(54) SPEED CHANGE OPERATION APPARATUS FOR A VEHICLE

(75) Inventors: Tetsuji Ohno, Shizuoka (JP); Yoshiyuki Suzuki, Shizuoka (JP); Shuji Muraki, Shizuoka (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA ATSUMITEC, Shizuoka (JP)

(21) Appl. No.: 12/163,930

(22) Filed: Jun. 27, 2008

(30) Foreign Application Priority Data
Jun. 28, 2007 (JP) 2007-170039

(51) Int. Cl. F16H 59/04

(52) U.S. Cl. 74/473.3

(57) ABSTRACT

A speed change operation apparatus for a vehicle for performing speed change operation of a transmission of a vehicle by a pivotal operation of an operating-lever shaft can comprise a body adapted to be mounted on a vehicle and an operating-lever shaft pivotally supported on the body. A metal core member can be rotated by pivotal operation of the operating-lever shaft. Coils can be arranged along a pivotal trajectory of the core member and can have a voltage applied thereto. Shift positions of the operating-lever shaft can be detected by variations of voltage caused by movement of the core member in the coils.

### PRIORITY INFORMATION

This application is based on and claims priority under 35 U.S.C. §119 to Japanese Patent Application No. 2007-170039, filed on Jun. 28, 2007, the entire contents of which is hereby expressly incorporated by reference herein.

### BACKGROUND OF THE INVENTIONS

1. Field of the Inventions

The present inventions relate to a speed changing operation apparatus for vehicle for carrying out the speed changing operation of a transmission.

2. Description of the Related Art

Speed changing operation apparatuses for vehicles generally comprise an operating lever shaft pivotally supported on a body of the speed change operation apparatus and a knob mounted on the tip end of the operating-lever shaft. Such devices allow a user to carry out a speed changing operation of the transmission of vehicle by pivotally operating the lever shaft with gripping the operating knob. These devices are also known as “gear shifters”.

In general, the shift positions of the operating-lever shaft are detected when an electric circuit is completed by the movement of a movable contact arranged on a portion of the lever shaft into contact with immovable contacts arranged on the body of the speed change operation apparatus. That is, it is possible to detect the shift position of the operating-lever shaft by completing the electric circuit by contacting the movable contact on the lever shaft with one of the plurality of immovable contacts corresponding to one of the shift positions.

### SUMMARY OF THE INVENTION

An aspect of at least one of the embodiments disclosed herein includes the realization that problems in the speed change operation apparatus of the prior art are caused by the large number of parts required and the work required for assembly since it is required to arrange the immovable contacts ate precise locations. Additionally, there is a large number of such immoveable contacts because there is one such contact for every predetermined shift position. In addition there is a problem that a dedicated manufacturing facility is required in accordance with different types of vehicles having different arrangements of the immovable contacts since the shift position (i.e. pivotal angle) of the operating-lever shaft is usually different in different types of vehicles.

Thus, in accordance with an embodiment, a speed change operation apparatus for a vehicle for performing speed change operation of a transmission of a vehicle by a pivotal operation of an operating-lever shaft, can comprise a body of the speed change operation apparatus adapted to be mounted on a vehicle. An operating-lever shaft can be pivotally supported on the body of the speed change operation apparatus. The speed change operation apparatus can further comprise a metal core member rotated by pivotal operation of the operating-lever shaft, and coils can be arranged along a pivotal trajectory of the core member and to which a voltage is applied. Shift positions of the operating-lever shaft can be detected by variations of voltage caused by movement of the core member in the coils.

In accordance with another embodiment, a shifter input device can comprise a body adapted to be mounted on a vehicle. An operating-lever shaft can be pivotally supported on the body. A metal core member can be rotated by pivotal operation of the operating-lever shaft. A plurality of coils can be arranged along a pivotal trajectory of the core member. Additionally, the coils can be arranged such that variations of voltage are caused by movement of the core member in the coils caused by pivotal operation of the operating-lever shaft.

### BRIEF DESCRIPTION OF THE DRAWINGS

Additional advantages and features of the present inventions will become apparent from the subsequent description and the appended claims, taken in conjunction with the accompanying drawings, wherein:

FIG. 1 is a side elevation view showing one embodiment of the speed change operation apparatus for a vehicle;

FIG. 2 is a front elevation view showing the speed change operation apparatus for a vehicle of FIG. 1;

FIG. 3 is a schematic view showing a shift position detecting means of the speed change operation apparatus for a vehicle of FIG. 1;

FIG. 4 is a cross-sectional view taken along a line IV-IV of FIG. 3;

FIG. 5 is a schematic view showing a substrate used in the speed change operation apparatus for a vehicle of FIG. 1; and

FIG. 6 is a schematic view showing a shift position detecting means of another embodiment of the speed change operation apparatus for a vehicle;

FIG. 7 is a cross-sectional view taken along a line VII-VII of FIG. 6; and

FIG. 8 is a graph showing a relation between the pivotal angle of the operating-lever shaft and the generated voltage in coils.

### DETAILED DESCRIPTION OF THE PREFERRED EMBODIMENT

The speed change operation apparatus for a vehicle of one embodiment can be used for performing speed change operation of a transmission of a vehicle. The speed change operation apparatuses disclosed herein are described in the context of a speed changing apparatus for a vehicle. However, the speed change operation apparatuses can have utility in other contexts, for example, wherever a knob is used on the end of a lever.

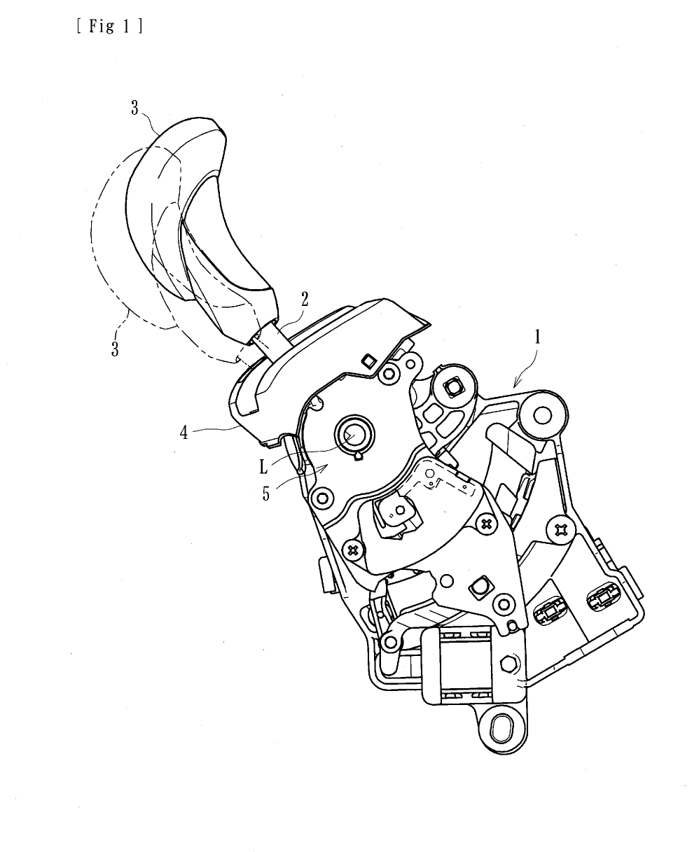

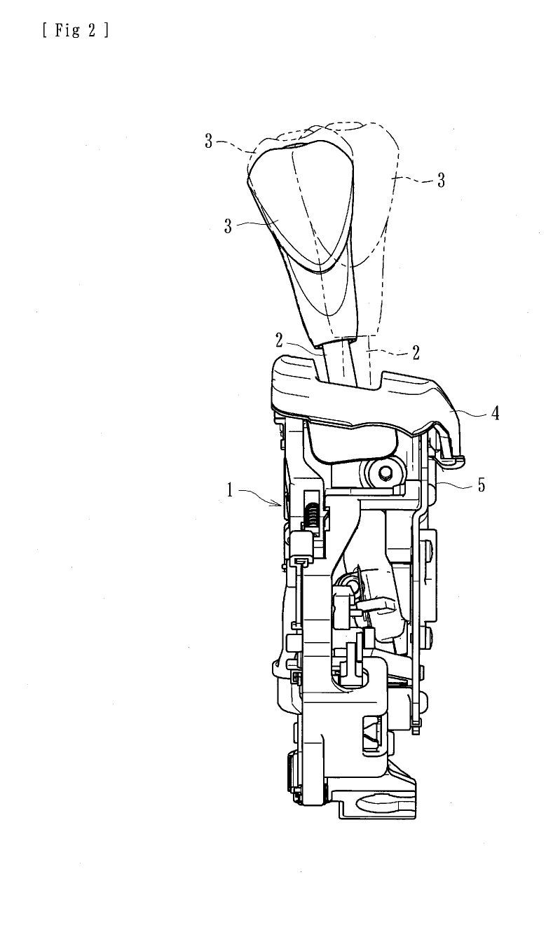

In some embodiments, the speed change operation apparatus can comprise, as shown in FIGS. 1 and 2, a body 1 adapted to be mounted on a vehicle, a operating-lever shaft 2 pivotally mounted and movable along a gate slot (not shown) formed in the top of the body 1 of the apparatus, an operating knob 3 mounted on the tip end of the operating-lever shaft 2, and a shift position detecting means 5.

The body 1 of the speed change operation apparatus can be adapted to be mounted on a body of vehicle and pivotally support the operating-lever shaft 2 and has on its top a decoration panel 4. The decoration panel 4 can be formed with the gate slot (not shown) through which the operating-lever shaft 2 can pass. The operating-lever shaft 2 can be a type which can move not only in fore and aft directions but in left and right directions, however other types which can move only in fore and aft directions can also be used.

The operating-lever shaft 2 can pivot around its pivotal shaft “L” between shift positions e.g. “P” position (Parking position), “R” position (Reverse position), “N” position (Neutral position), “D” position (Drive position) and “L” position (Low position) to perform speed changing operation of the transmission of vehicle. That is, the operating-lever shaft 2 is so structured that it is pivoted between a plurality of shift positions (five positions in the illustrated embodiment) to perform speed changing operation of the transmission of vehicle with a shift position detecting means 5 detecting the shift position of the operating-lever shaft 2.

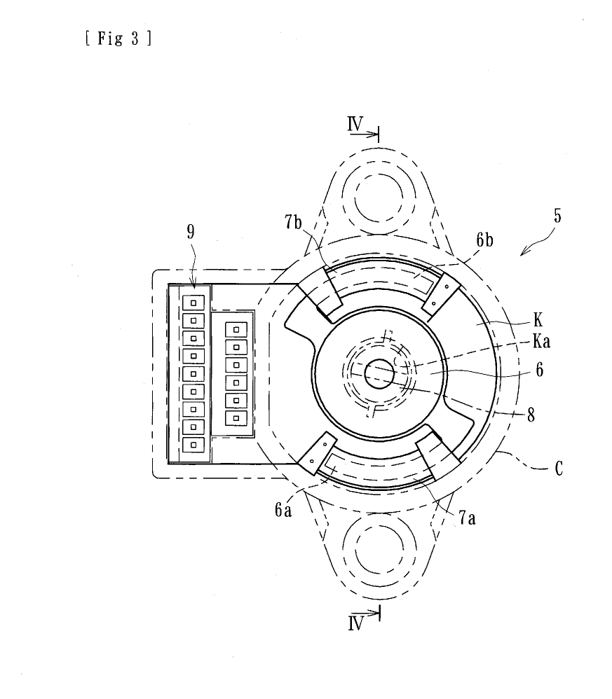

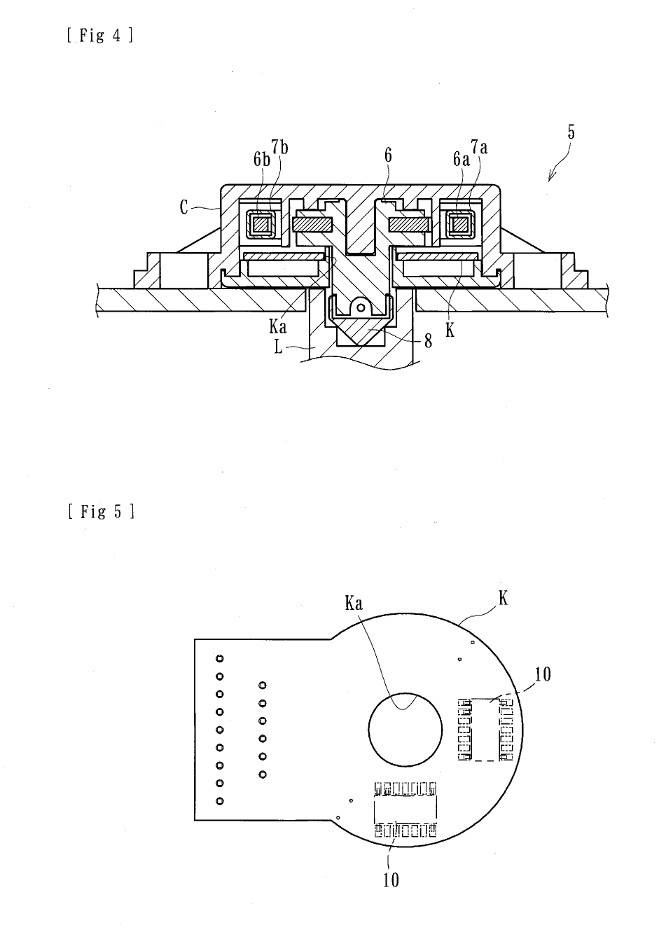

As shown in FIGS. 3-5 the shift position detecting means 5 can comprise a core member 6 of metal contained in a plastic case “C”, coils 7a, 7b, a substrate “K”, and an IC chip 10 mounted on the substrate “K”. The substrate “K” can be formed with a through aperture Ka substantially at its center and a connector 9 for transmitting detected signals to a receiver at a transmission side and secured in the case “C”.

The core member 6 can be passed through the aperture Ka of the substrate and connected to the pivotal shaft “L” of the operating-lever shaft 2 via a connecting member 8 and can have first and second extensions 6a, 6b each having a circular arc configuration. When the metal core member 6 is rotated by the pivotal movement of the operating-lever shaft 2 around the pivotal shaft “L”, the first and second extensions 6a, 6b of the core member 6 are also rotated in a same direction and a same distance as those of the core member 6. Although the core member may be wholly formed of metal, only at least the first and second extensions 6a, 6b may be formed of metal.

The coils 7a, 7b can be adapted to be applied by a voltage and arranged so that they extend along a pivotal trajectory of the core member 6 (more particularly the extensions 6a, 6b of the core member 6). In some embodiments, a plurality of coils can be provided and the number (two in the illustrated embodiment) of coils corresponds to that of the extensions (i.e. the extensions 6a, 6b in the illustrated embodiment). That is, the first and second extensions 6a, 6b can be moved within the coils 7a, 7b when the core member 6 is rotated by the operating-lever shaft 5.

The voltage generated in coils 7a, 7b can be varied in accordance with an amount of displacement of the first and second extensions 6a, 6b as shown in FIG. 8 when they move within the coils 7a, 7b. The variation of voltage is detected by the IC chip 10 mounted on the substrate “K” and thus it is possible to detect the shift position of the operating-lever shaft 2 on the basis of the variation of voltage. For example, the voltage generated in coils 7a, 7b at each shift position of the operating-lever shaft 2 can be previously determined and stored in the IC chip 10 and thus the shift position of the operating-lever shaft 2 can be detected by comparing the voltage generated in the coils 7a, 7b with the voltage data stored in the IC chip 10.

Since the voltage variation caused in the coil 7a by movement of the first extension 6a of the core member 6 is same as that caused in the coil 7b by movement of the second extension 6b of the core member 6, the failsafe of the sensors can be achieved. This enables detection of the shift position of the operating-lever shaft 2 more accurately and more firmly and thus improves safety of driving of a vehicle. Although the failsafe is achieved by so setting that the voltage variation in the coil 7a and that in the coil 7b are same each other, it may be possible to achieve same object by setting the voltage variations in the coils 7a, 7b in reverse directions (i.e. a voltage in one coil is increase and a voltage in the other coil is decreased in accordance with the pivotal movement of the operating-lever shaft). In this case it is judged that the indication of the shift position of the operating-lever shaft is normal if the sum of the voltages equals to the set value.

According to the illustrated embodiment, since the shift position of the operating-lever shaft 2 can be detected on the basis of the voltage variation caused by movement of the first and second extensions 6a, 6b of the core member 6 in the coils 7a, 7b, the shift position of the operating-lever shaft 2 can be detected accurately and by a low cost means. That is, in some embodiments, since the shift position of the operating-lever shaft 2 can be detected continuously, it is unnecessary to provide sensors at every shift positions and thus it is possible to reduce the number of parts and manufacturing cost of the speed change operation apparatus and to improve its workability in assembly.

The present speed change operation apparatuses can be applied to any types of speed change operation apparatus only by changing memories in the IC chip 10 and thus shared between different types of vehicles. That is, the shift position of the operating-lever shaft can be detected easily and accurately even in various types of vehicles in which the operating position and the pivotal angle of the lever shaft are different.

In addition, the shift position of the operating-shaft lever 2 can be detected by a non-contact manner. This enables to extend the service life of sensors and to achieve the detection of high accuracy as compared with the detecting structure using electrical contacts of the prior art. In addition, since the core member 6, in accordance with some embodiments, has a plurality of extensions (first and second extensions 6a, 6b in the illustrated embodiment) and a plurality of coils (coils 7a, 7b in the illustrated embodiment) are arranged corresponding to the extensions, it is possible to obtain a plurality of detected signals corresponding to the shift positions of the operating-lever shaft 2 on the basis of the voltage variation of the coils and thus to generate two or more kinds of detected signals based on the shift positions of the operating-lever shaft 2.

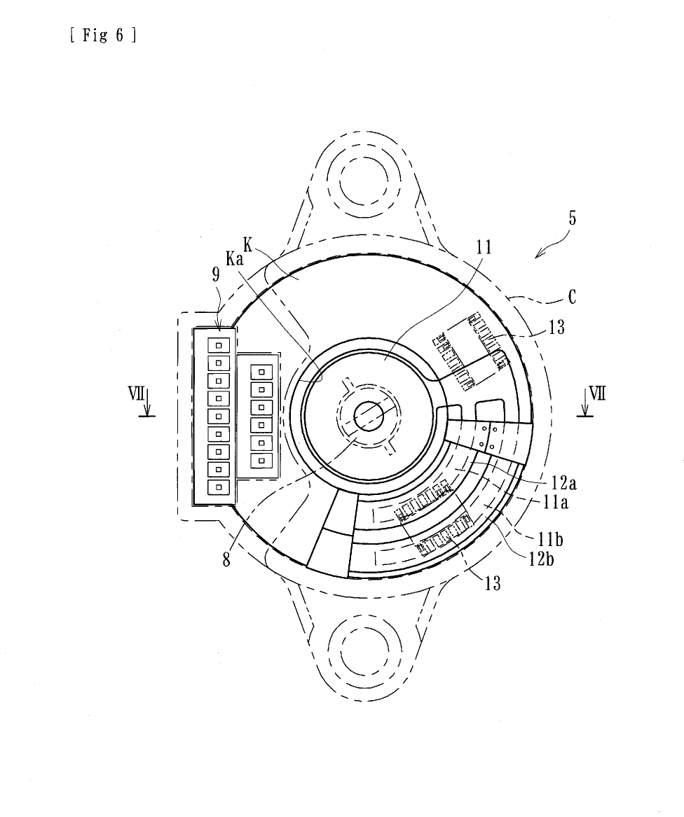

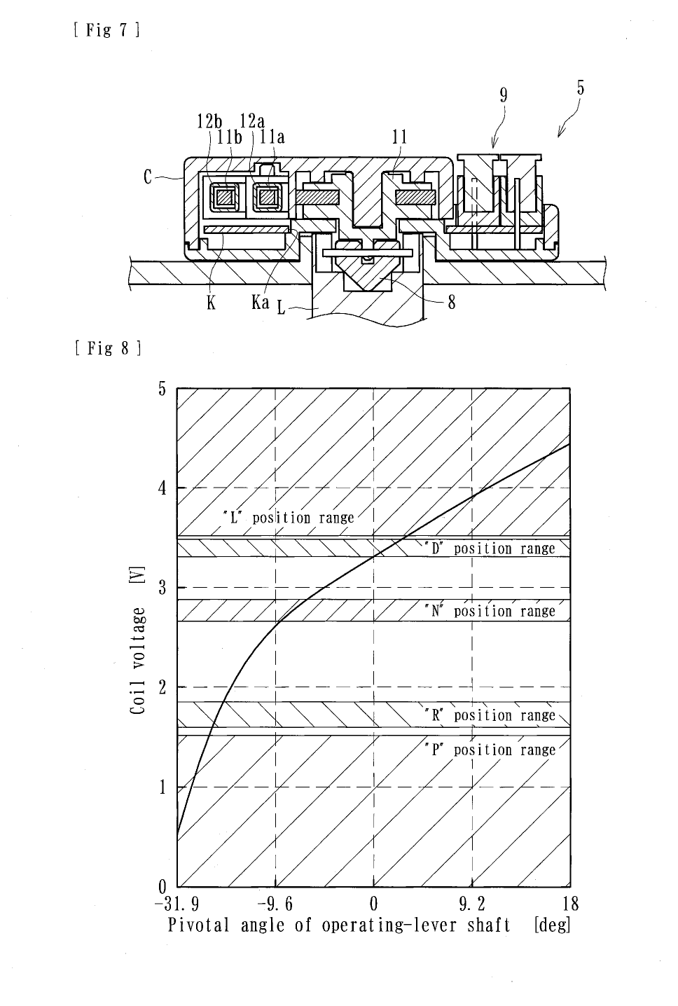

FIGS. 6 and 7 show another embodiment which is different in arrangement of the core member and the coils from those of the previously described and illustrated embodiment. The core member 11 of this embodiment can have an inner first extension 11a and an outer second extension 11b each having a circular arc configuration. Coils 12a, 12b can be arranged along a pivotal trajectory respectively of the first and second extensions 11a, 11b. At least the first and second extensions 11a, 11b of the core member 11 are made of metal similarly to those of the previous embodiment.

Similarly to the previous embodiment, a voltage generated in coils 12a, 12b varies when the core member 11 is rotated by the pivotal movement of the operating-lever shaft 2. This voltage variation is detected by the IC chip 13 mounted on the substrate and the shift position of the operation-lever shaft 2 can be detected based on the voltage variation. It is possible to use a plurality of IC chips 13 on the basis of the number of the extensions of the core member 11 and coils. This is also applied to the number of the IC chip 10 of the previous embodiment.

The provision of plurality of IC chips 13 enables, on one hand, transmission of detected signals generated by voltage variation e.g. of the coil 12a to a transmission side of a vehicle and the other hand, transmission of detected signals generated by voltage variation e.g. of the coil 12b to a indicator in an instrument panel of a vehicle. That is, since a plurality of detected signals are generated corresponding to the shift positions of the operating-lever shaft 2 on the basis of the voltage variations of each coil 12a, 12b, it is possible to generate two or more kinds of detected signals based on the shift positions of the operating-lever shaft 2.

The present inventions have been described with reference to certain embodiments. Obviously, modifications and alternations will occur to those of ordinary skill in the art upon reading and understanding the preceding detailed description. For example, only one extension can be provided on the core member and one coil corresponding to the extension can be provided along a pivotal trajectory of the extension. On the contrary, three or more extensions can be formed on the core member and corresponding numbers of coils can be arranged. That is, it is possible to arrange coils corresponding to the number of the extensions of the core and to generate a plurality of detected signals corresponding to the number of the shift position of the operating-lever shaft based on voltage variations of each coil.

In addition although it is shown in the illustrated embodiments that the core members 6, 11 are mounted on the pivotal shaft “L” of the operating-lever shaft 2, the core members can be arranged in any part which is rotated interlocking with a pivotal movement of the operating-lever shaft 2. Furthermore the configuration of each extension is not limited to a circular arc and any configuration can be adopted if it can move in a coil in accordance with the pivotal movement of the operating-lever shaft.

The speed change operation apparatuses disclosed herein can be applied to any speed change operation apparatus having a different outline configuration or additional functions if it is a speed change operation apparatus characterized in that the speed change operation apparatus further comprises a metal core member rotated by pivotal operation of the operating-lever shaft, and coils arranged along a pivotal trajectory of the core member; and that shift positions of the operating-lever shaft can be detected by variations of voltage caused by movement of the core member in the coils.

What is claimed is:

1. A speed change operation apparatus for a vehicle for performing speed change operation of a transmission of a vehicle by a pivotal operation of an operating-lever shaft, comprising:
a body of the speed change operation apparatus adapted to be mounted on a vehicle;
an operating-lever shaft pivotally supported on the body of the speed change operation apparatus;
wherein the speed change operation apparatus further comprises a metal core member rotated by pivotal operation of the operating-lever shaft, and coils arranged along a pivotal trajectory of the core member and to which a voltage is applied; and
wherein shift positions of the operating-lever shaft are detected by variations of voltage caused by movement of the core member in the coils.

2. A speed change operation apparatus of claim 1, wherein the core member has a plurality of extensions extending therefrom to different directions and the coils are arranged corresponding to the extensions, and wherein a plurality of detected signals corresponding to the shift positions of the operating-lever shaft are generated on the basis of the voltage variations of the coils.

3. A speed change operation apparatus of claim 2 wherein the detected signals include at least a failsafe signal.

4. A shifter input device, comprising:
a body adapted to be mounted on a vehicle;
an operating-lever shaft pivotally supported on the body;
a metal core member rotated by pivotal operation of the operating-lever shaft;
a plurality of coils arranged along a pivotal trajectory of the core member; and
wherein the coils are arranged such that variations of voltage are caused by movement of the core member in the coils caused by pivotal operation of the operating-lever shaft.

5. A speed change operation apparatus of claim 4, wherein the core member has a plurality of extensions extending therefrom to different directions and the coils are arranged corresponding to the extensions, and wherein a plurality of detected signals corresponding to the shift positions of the operating-lever shaft are generated on the basis of the voltage variations of the coils.

6. A speed change operation apparatus of claim 5 wherein the detected signals include at least a failsafe signal.
